(19) United States
(12) Patent Application Publication
(10) Pub. No.: US 2005/0267849 A1
(43) Pub. Date: Dec. 1, 2005

(54) Method and system to reduce feeding and weighing errors in manual feed mailing systems

(75) Inventors: Gary S. Jacobson, Norwalk, CT (US); Wesley A. Kirschner, Hamden, CT (US); Joseph M. Mozdzer, Shelton, CT (US); Konstantin G. Kodonas, Norwalk, CT (US); Joseph P. Tokarski, Prospect, CT (US)

Correspondence Address: Pitney Bowes Inc.;Intellectual Property and Technology Law Dep., 35 Waterview Drive, P.O. Box 3000, Shelton, CT, 06484, US

(73) Assignee: Pitney Bowes Incorporated, Stamford, CT (US)

(21) Appl. No.: 10/857,992

(22) Filed: Jun. 1, 2004

(51) Int. Cl. G06F 17/00

(52) U.S. Cl. 705/407

(57) ABSTRACT

Methods and systems are provided that reduce feeding and weighing errors in a manually fed mailing machine thereby allowing a very fast throughput to be achieved while a user is taking mail pieces off of a scale and feeding them into the mailing machine. Weights or postage amounts for additional subsequent mail pieces are accepted before the processing of a preceding mail piece has been completed. A queue is maintained for information that has been provided by an attached scale such that the mailing machine can correctly associate each weight or postage amount with the appropriate mail piece when it is fed into the mailing machine. When processing of a previous mail piece has been completed, the information from the next location in the queue is obtained and utilized to generate an indicium for the next mail piece fed into the mailing machine.

### FIELD OF THE INVENTION

The invention disclosed herein relates generally to mail processing systems, and more particularly to a manually fed mailing machine incorporating systems and methods to reduce feeding and weighing errors.

### BACKGROUND OF THE INVENTION

Mail processing equipment, such as, for example, a mailing machine, often includes different modules that automate the process of producing mail pieces. The typical mailing machine includes a variety of different modules or sub-systems each of which performs a different task on the mail piece. The mail piece is conveyed downstream utilizing a transport mechanism, such as rollers or a belt, to each of the modules. Such modules could include, for example, a singulating module, i.e., separating a stack of mail pieces such that the mail pieces are conveyed one at a time along the transport path, a moistening/sealing module, i.e., wetting and closing the glued flap of an envelope, and a metering module, i.e., applying evidence of postage to the mail piece. The exact configuration of the mailing machine is, of course, particular to the needs of the user.

One of the factors that determines the cost for shipping a mail piece to a destination is the weight of the mail piece. A mail piece could be, for example, an envelope, postcard, magazine, package, etc. The mailing machine will be provided with the weight of the mail piece, typically from an integral scale incorporated within the mail flow path, an external scale coupled to the mailing machine, or user input. Based on the weight of the mail piece, the postage rate and operator specified service option for a selected carrier, the mailing machine will determine the cost to deliver the mail piece to the destination. The mailing machine will then conduct an accounting procedure for the cost of shipping the mail piece and print an indicium evidencing payment of the postage. Mailing machines have traditionally been capable of printing postage indicia either directly on mail pieces, or on pieces of tape or a label, which are then attached to mail pieces.

For mailing systems that utilize an external platform scale, i.e., a scale that is independent and separate from the mail flow path, there are different methods that can be utilized for determining the weight of an item. In one method, referred to as single piece mode, the user places each mail piece onto the platform of the external scale, and the weight of the mail piece is provided by the scale to the controller of the mailing machine. The controller will calculate the cost for shipping the mail piece based on the weight of the mail piece provided by the scale. The user removes the mail piece from the scale and places it on the feed deck of the mailing machine base. Sensors detect the presence of the mail piece on the feed deck and the mail piece is automatically fed into the mailing machine for processing, or, alternatively, the user must press a start button for the mailing machine to transport the mail piece into the mail flow path. The user then repeats this procedure for each mail piece that the user desires to process.

Another method for determining the weight of a mail piece is referred to as a differential weighing method as disclosed in U.S. Pat. No. 5,001,648, which is hereby incorporated by reference. In accordance with the differential weighing method, a plurality of mail pieces are placed on an external scale coupled to a mailing machine and the collective weight of the mail pieces is registered. When the user removes a mail piece from the scale, the difference between the original collective weight of the mail pieces and the new collective weight of the mail pieces remaining on the scale is determined. The cost for shipping of the mail piece is calculated based on the determined differential weight. Sensors detect the presence of the mail piece on the feed deck and the mail piece is preferably automatically fed into the mailing machine for processing. The user then repeats this procedure for each mail piece that the user desires to process.

While conventional manual feed mailing machines generally work well utilizing the weighing methods as described above, there are some problems. For example, there are several ways in which mistakes made by the user in feeding the mail pieces and/or removing/adding a mail piece from/to the scale can result in the calculation and printing of incorrect postage for a mail piece. This is especially true if the user is attempting to process the mail pieces as quickly as possible. For example, the user may place and remove a second mail piece (in single piece mode) or remove a second mail piece (in differential weighing mode) while a previous first mail piece is still being processed by the mailing machine. Conventional mailing machines will not accept the weight of the second mail piece until the first mail piece has been completely processed. This significantly reduces the throughput of the mailing machine, as well as frustrates the user due to the waiting time required between mail pieces. If the user attempts to weigh the second mail piece before the first mail piece has been fully processed, the postage for the second mail piece will not be calculated, and the second mail piece will not be fed into the mailing machine by the transport system. Thus, the second mail piece will simply sit on the feed deck of the mailing machine and no further operations will occur. The user, not knowing that the weight of the second mail piece was not accepted by the mailing machine, and thus will not be processed, may believe that there is a problem with the sensors or feeding mechanism of the mailing machine. The user may be inclined to restart the entire system, which is time consuming, thereby decreasing the throughput of the mailing machine, or place a service call in the belief that the mailing machine is in need of repair. In either case, this can lead to general dissatisfaction with the mailing machine by the user.

Another feeding and weighing error that can occur is if the user forgets to place a mail piece on the scale, and instead places it directly onto the feed deck. If the controller does not have a weight for the mail piece, the mail piece will not be fed into the mailing machine. The user, not realizing that the mail piece was never weighed, and thus will not be processed, may believe that there is a problem with the sensors or feeding mechanism of the mailing machine. The user may be inclined to restart the entire system, which is time consuming, or place a service call in the belief that the mailing machine is in need of repair. In either case, this can lead to general dissatisfaction with the mailing machine by the user.

Thus, there exists a need for a method and system that reduces feeding and weighing errors in a manually fed mailing machine.

### SUMMARY OF THE INVENTION

The present invention alleviates the problems associated with the prior art and provides methods and systems that reduce feeding and weighing errors in a manually fed mailing machine thereby allowing a very fast throughput to be achieved while maintaining mail piece integrity, i.e., associating each mail piece with the proper information for that mail piece.

In accordance with embodiments of the present invention, a mailing machine accepts weights or postage amounts for additional subsequent mail pieces before the processing of a preceding mail piece has been completed. The mailing machine maintains a queue of the weights or postage amounts for a plurality of mail pieces that have been provided by an attached scale such that the mailing machine can correctly associate each weight or postage amount with the appropriate mail piece when it is fed into the mailing machine. When processing of a previous mail piece has been completed, the weight or postage amount from the next location in the queue is obtained and utilized to generate an indicium for the next mail piece fed into the mailing machine. The mailing machine therefore can form the correct processing order for multiple pieces of mail, thereby increasing the throughput of the mailing machine.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 illustrates a mailing machine having systems and methods for reducing feeding and weighing errors according to embodiments of the present invention;

FIG. 2 illustrates in block diagram form portions of the mailing machine of FIG. 1; and

FIGS. 3A-3C illustrate an example of a queue used to reduce feeding and weighing errors according to an embodiment of the present invention.

### DETAILED DESCRIPTION OF THE PRESENT INVENTION

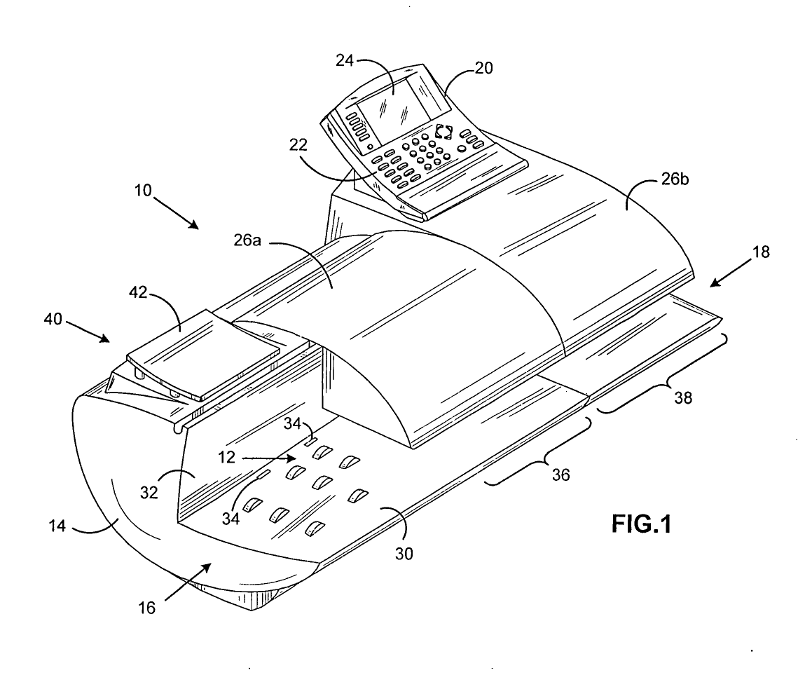

In describing the present invention, reference is made to the drawings, wherein there is seen in FIG. 1 a mailing machine 10 that includes systems and methods for reducing feeding and weighing errors according to embodiments of the present invention. Mailing machine 10 comprises a base unit, designated generally by the reference numeral 14, the base unit 14 having a mail piece input end, designated generally by the reference numeral 16, and a mail piece output end, designated generally by the reference numeral 18. A control unit 20 is mounted on the base unit 14, and includes one or more input/output devices, such as, for example, a keyboard 22 and a display device 24. Control unit 20 preferably includes one or more controller units, such as, for example, a microprocessor, general or special purpose processor or the like, to control operation of the mailing machine 10. One or more cover members 26a, 26b are pivotally mounted on the base 14 so as to move from the closed position shown in FIG. 1 to an open position (not shown) to expose various operating components and parts for service and/or repair as needed.

The base unit 14 further includes a horizontal feed deck 30 which extends substantially from the input end 16 to the output end 18. A plurality of nudger rollers 12 are preferably mounted under the feed deck 30 and project upwardly through openings in the feed deck so that the periphery of the rollers 12 is slightly above the upper surface of the feed deck 30 and can exert a forward feeding force on a succession of mail pieces placed in the input end 16. One or more sensors 34, such as, for example, optical sensors, are located in the feed deck 30 to detect the presence of a mail piece on the feed deck 30. A registration wall 32 defines a mail piece registration surface substantially perpendicular to the feed deck 30 that extends substantially from the input end 16 to the output end 18. A scale 40, including a platter 42 (which may be removable), is preferably located near the input end 16, such as, for example, above and adjacent to the registration wall 32 as illustrated. Components of the weighing scale 40 other than the platter 42, including a load cell and related electronics, can be located within the base unit 14. Thus, while the scale 40 may be integral with the base unit 14, it is still considered an external platform scale as it is independent and separate from the mail flow path along the feed deck 30. Alternatively, a separate external stand alone scale (not shown) may be coupled to the mailing machine 10 by any suitable communication link, such as, for example, a USB or RS232 interface.

The scale 40 can be operated by a user to weigh mail pieces utilizing either the single piece mode or differential weighing mode previously described. When the mail pieces are removed from the platter 42 of the scale 40, the user places the mail piece in the input end 16 where one or more of the sensors 34 detect the mail piece. Signals from the sensors 34 are sent to the control unit 20, which in response, will activate the nudger rollers 12 to feed the mail piece along the feed deck 30, with the top edge of the mail piece being registered against the registration wall 32. Alternatively, control unit 20 may require an input from the user, such as, for example, pressing a start button, in lieu of or in addition to the signal from sensors 34, before activating the nudger rollers 12. The mail pieces may be passed through one or more modules, such as, for example, a singulator module and a moistening/sealing module, as are well known. Each of these modules is located generally in the area indicated by reference numeral 36. The mail pieces are then passed to a metering/printing module located generally in the area indicated by reference numeral 38, where an indicium evidencing postage will be printed on the mail piece. Alternatively, if a mail piece is not fed through the mailing machine 10, the indicium may be printed on a tape or label that can be affixed to the mail piece.

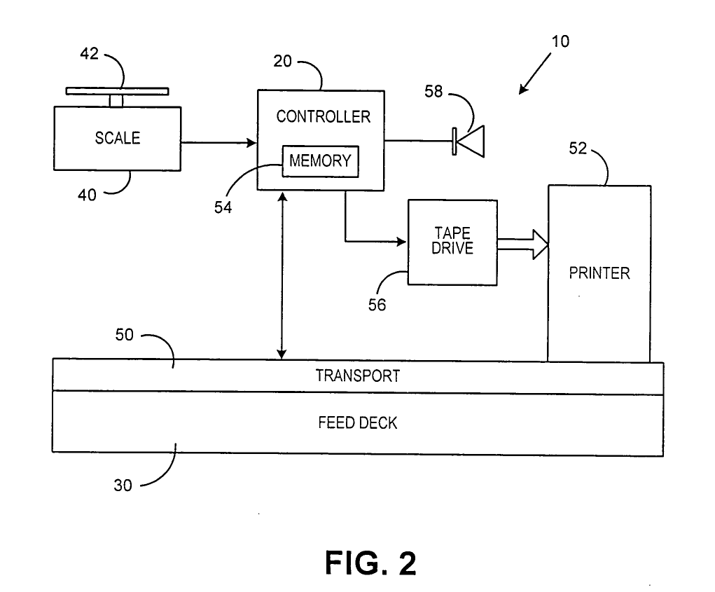

FIG. 2 illustrates in block diagram form portions of the mailing machine 10 illustrated in FIG. 1. As illustrated in FIG. 2, a transport 50, including, for example, the nudger rollers 12 of FIG. 1, utilized to transport mail pieces along the feed deck 30 is coupled to the control unit 20 and transports mail pieces based on signals provided from the control unit 20. The transport 50 will transport the mail pieces through the modules of the mailing machine 10, including a printer 52, wherein printing can occur on each mail piece. The scale 40 is coupled to the control unit 20. Scale 40 can provide the weight of an object on the scale 40 to control unit 20, or could provide a representative signal to control unit 20 from which the control unit 20 will determine the weight of the object. The control unit 20 will determine the necessary postage costs for a mail piece, based at least in part on the weight of the mail piece as received from the scale 40, utilizing one or more rating tables that can be stored in the memory 54. Alternatively, if rating tables are stored within the scale 40, the scale 40 could provide the postage costs for a mail piece to the control unit 20. Control unit 20 will generate an indicium, based on the determined postage cost, for printing on the mail piece by printer 52 as the mail piece is transported past the printer 52. Alternatively, control unit 20 can activate the tape drive 56 to deliver a tape to the printer 52, and the printer 52 will print the indicium on the tape for adhering to a mail piece.

Since each mail piece must be placed on the platter 42 of scale 40 and then removed and placed on the feed deck 30 for single piece mode operation, and each mail piece must be removed from a stack of mail pieces previously placed on the platter 42 and placed on the feed deck 30 for differential weighing mode operation, efficient operation of the mailing machine 10 is dependent upon the user. As the user will typically attempt to operate the mailing machine 10 as quickly as possible to achieve the greatest throughput, it is possible for errors to occur with respect to weighing and feeding of the mail pieces. In addition, an unscrupulous user may attempt to trick the system into printing the incorrect postage on a mail piece, such as, for example, by not weighing a mail piece, thereby defrauding the postal service of the proper amount of funds due. Mailing machine 10 is provided with multiple mechanisms as described below to reduce weighing and feeding errors that could occur due to operator error, whether intentional or unintentional, thereby providing efficient and accurate operation of the mailing machine 10.

Depending upon the speed at which the user can operate, i.e., place and/or remove mail pieces from the platter 42, it may be possible for the user to remove a mail piece from the platter 42 while another preceding mail piece is being processed by the mailing machine 10. Thus, there could be, for example, one mail piece currently being transported along the feed deck 30 by the transport 50, another mail piece placed in the input end 16 of the mailing machine 10 to be fed into the mailing machine 10, and another mail piece in the user's hand waiting to be placed in the input end 16. According to one embodiment, mailing machine 10 maintains a queue of weights that have been provided by the scale 40 such that the mailing machine 10 can correctly associate each weight with the appropriate mail piece. Alternatively, if the scale 40 is calculating the postage amount for each mail piece, mailing machine 10 maintains a queue of postage costs that have been provided by the scale 40 such that the mailing machine 10 can correctly associate each postage amount with the appropriate mail piece. Preferably, the memory 54 can be utilized to maintain the queue of weights or postage amounts. When a previous piece has been completed, the control unit 20 will obtain the weight or cost from the next location in the queue, utilize the obtained weight to calculate the postage amount based on a rating table within the memory 54, and generate an indicium for the postage amount for printing by the printer 52. The indicium could be printed either directly on the mail piece, or on a tape from the tape drive 56.

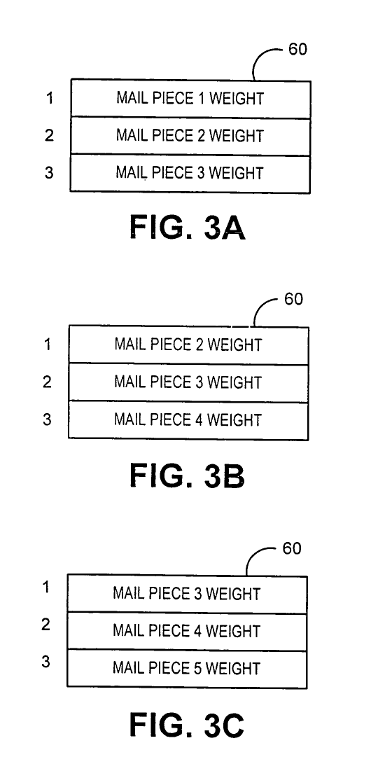

FIGS. 3A-3C illustrate an example of a queue 60 maintained in memory 54 during operation of mailing machine 10 according to an embodiment of the invention. Suppose the weight of a first mail piece (Mail Piece 1) has been determined by the scale 40 (either in the single piece mode or differential weighing mode) and the user has placed Mail Piece 1 on the feed deck 30. The weight for Mail Piece 1 is accepted by the control unit 20 and stored in the first location in the queue 60, where it will be retrieved by the control unit 20 to calculate the postage for Mail Piece 1. Alternatively, the weight for Mail Piece 1 need not be stored in the queue 60 and can be directly accepted by the control unit 20 for calculation of postage. While Mail Piece 1 is being processed by the mailing machine 10, the user places and removes (for single piece mode) or just removes (for differential weighing mode) a second mail piece (Mail Piece 2) from the scale 40. The determined weight of Mail Piece 2 is accepted by the control unit 20 and stored in the second location in the queue 60 for retrieval at the appropriate time, as described below, to calculate the postage for Mail Piece 2. The user can place Mail Piece 2 on the input end 12 of the feed deck 30, which may have been vacated by Mail Piece 1 being drawn into the mailing machine 10. Alternatively, if Mail Piece 1 has not yet vacated the input end 12 of the feed deck 30, Mail Piece 2 could be placed on top of Mail Piece 1, as a singulator (not shown) can separate the two mail pieces and feed the bottom mail piece, i.e., Mail Piece 1, into the mailing machine 10. If the user now places and removes or removes a third mail piece (Mail Piece 3) from the scale 40, the determined weight of Mail Piece 3 is accepted by the control unit 20 and stored in the third location in the queue 60 for retrieval at the appropriate time.

Once the weight for Mail Piece 1 has been retrieved by the control unit 20, the weights for the other mail pieces (Mail Pieces 2 and 3) will shift upward thereby emptying the third location of the queue. If the weight for Mail Piece 1 is not stored in the queue 60, then the weight of Mail Piece 2 will be stored directly in the first location of queue 60, the weight of Mail Piece 3 will be stored in the second location of queue 60. Once the processing for Mail Piece 1 has been fully completed, i.e., accounting has been performed for Mail Piece 1, an indicium has been generated and the generated indicium has been printed on Mail Piece 1, the control unit 20 can then retrieve the weight for Mail Piece 2 stored in the queue 60. Preferably, the weight for Mail Piece 2 is retrieved as soon as the processing for Mail Piece 1 has been completed, thereby avoiding any unnecessary delays which will decrease the throughput of mailing machine 10. Sensors 34, detecting the presence of Mail Piece 2 on the feed deck 30, will send a signal to the control unit 20. Control unit 20 will confirm that a weight for Mail Piece 2 has been retrieved and processing of Mail Piece 1 has been completed, and then activate the nudger rollers 12 to feed Mail Piece 2 into the mailing machine 10 for processing. Alternatively, Mail Piece 2 can be ingested into the mailing machine 10 as soon as the signal from sensors 34 is received, but paused downstream until the other two conditions have been satisfied. Mail Piece 3 can then be placed on the feed deck 30 (if Mail Piece 2 has left) or on top of Mail Piece 2 (if Mail Piece 2 has not left), and the user can retrieve the fourth mail piece (Mail Piece 4). The weight for Mail Piece 4 will be accepted by the control unit 20 and stored in the third location of the queue 60 as illustrated in FIG. 3B. When the weight for Mail Piece 2 is retrieved by the control unit 20, the weights for the other mail pieces (Mail Piece 3 and 4) will shift upward thereby emptying the third location in the queue 60. Once the processing for Mail Piece 2 has been completed, the control unit 20 can then retrieve the weight for Mail Piece 3 stored in the queue 60. Sensors 34, detecting the presence of Mail Piece 3 on the feed deck 30, will send a signal to the control unit 20. Control unit 20 will confirm that a weight for Mail Piece 3 has been retrieved and processing of Mail Piece 2 has been completed, and then activate the nudger rollers 12 to feed Mail Piece 3 into the mailing machine 10 for processing. Alternatively, Mail Piece 3 can be ingested into the mailing machine 10 as soon as the signal from sensors 34 is received, but paused downstream until the other two conditions have been satisfied. Mail Piece 4 can then be placed on the feed deck 30 (if Mail Piece 3 has left) or on top of Mail Piece 3 (if Mail Piece 3 has not left), and the user can retrieve the fifth mail piece (Mail Piece 5). The weight for Mail Piece 5 will be accepted by the control unit 20 and stored in the third location of the queue 60 as illustrated in FIG. 3C. The processing continues in a similar fashion for subsequent mail pieces. While FIGS. 3A-3C illustrate a queue 60 utilized to store weights, it should be understood that if the scale 40 is determining the postage amount, the queue 60 could also be used to store the postage amounts received from the scale 40 and the processing would be similar as that described above with the control unit 20 retrieving the postage amount for each mail piece.

It should be understood that queue 60 is not limited to three locations as illustrated, but instead can have any number of locations depending upon the rate of speed desired. For example, the queue 60 could have one, two, three or more locations. If the user is capable of manually removing the mail pieces faster than the mailing machine 10 can process them, the user may remove more pieces than queue 60 can store, thereby running the risk of the mailing machine 10 not being in synchronization with the mail pieces being processed, i.e., the wrong weight being associated with the wrong mail piece. To alleviate this risk, some embodiments will monitor the queue 60, and once the queue 60 has been filled to capacity, only those pieces for which there is a corresponding entry in the queue 60 will be processed by the mailing machine 10 and no further entries will be made in the queue 60, even as space becomes available. Thus, once the queue 60 has been completely emptied, any mail pieces remaining on the feed deck 30 will not be processed by the mailing machine 10. A message will be provided to the user, utilizing, for example, display 24, that the processing limit was reached, i.e., mail pieces were removed too quickly, and any mail pieces that are not accepted by the mailing machine 10 (once the queue 60 has emptied) must be placed back on the platform 42 to obtain a weight. In this manner, the chance of the mailing machine 10 being out of synchronization with the mail pieces as fed by the user is significantly reduced. Optionally, the size of the queue 60 could be configurable depending upon the customer's specifications. For example, experienced users, capable of operating at a faster rate than inexperienced users, may desire a larger queue. Thus, if a user continually reaches the processing limit, the size of the queue can be increased to accommodate the faster rate of speed at which the user is capable of operating. The owner of a mailing machine being used by less experienced users, such as may be found in a community mailroom, may desire a smaller queue to safeguard against the mailing machine 10 being out of synchronization with the mail pieces and thus wasted postage funds.

Optionally, mailing machine 10 could be provided with means to provide an audible signal to the user indicating when the next mail piece can be removed from the platter 42. Such an audio signal could be provided by a speaker 58 (FIG. 2) coupled to the control unit 20. This will help to ensure that the queue 60 does not completely fill, thereby providing continuous operation of the mailing machine 10 at the greatest possible throughput. For example, in single piece mode, the user may place a subsequent mail piece on the platter 42 as soon as a previous one is removed. While scale 40 may be providing the weight to control unit 20, control unit 20 will not accept the weight until a location is available in the queue 60. In differential weighing mode, the mail pieces are already on the platter 42, but the weight for the next removed mail piece will not be accepted by the control unit 20 until a location is available in the queue 60. Thus, once a location within the queue 60 becomes available, the control unit 20 will cause the speaker 58 to emit an audible signal, thereby indicating to the user that the next mail piece can be removed from the platter 42, as the weight will be accepted by the control unit 20 and stored in the queue 60. If the queue is not full, the audible signal will be provided almost immediately after a mail piece is removed. Optionally, the control unit 20 can cause the speaker 58 to emit different audible signals based on the status. For example, a first audible signal can be emitted to indicate to the user that the queue is now full and the user must wait before removing the next mail piece from the platter 42, and then a second audible signal can be emitted to indicate to the user that he may resume processing and the next mail piece can be removed from the platter 42.

Thus, utilizing the queue 60, mailing machine 10 is able to accept the weights for additional mail pieces, even while preceding mail pieces are being processed by the mailing machine 10. This can significantly increase the throughput of the mailing machine 10 as compared with conventional mailing machines that required waiting for a previous mail piece to be fully processed before accepting the weight of the subsequent mail piece. In addition, a configurable queue size along with the use of messages to indicate to the user when processing limits were reached will help the user to optimize performance of the mailing machine 10 for each user.

According to another embodiment of the invention, the use of the queue 60 allows the mailing machine 10 to perform a maintenance operation for the print head of printer 52 when the maintenance operation is requested, instead of having to wait until the end of a mail run. Such maintenance includes, for example, a wipe of the print head or a purge of the print head, and is required to ensure that all nozzles of the print head are properly operating. The print head is typically moved to a maintenance position, maintenance is performed, and the print head is returned to the home position for printing. Thus, after a predetermined amount of time or number of print head cycles, the control unit 20 (or a separate printer controller (not shown)) will require a maintenance operation to be performed on the print head of the printer 52. It should be noted that such a maintenance operation may be required asynchronously, i.e., while a mail piece is traveling through the mailing machine 10. In conventional mailing systems, the maintenance operation, if possible, would be delayed until the end of a mail run, e.g., when the user has completed processing all pieces of the current batch. Some maintenance operations cannot be delayed until the end of the mail run, but instead would stop the mail run to perform the maintenance operation. The user would then be required to restart the mail run, adding additional delay to the processing of the mail run. Mailing machine 10, according to an embodiment of the present invention, allows the transport 50 to pause when a maintenance operation is requested, thereby allowing the printer maintenance to occur when requested, without having to stop and then restart the mail run. For example, the mail piece could be held on the feed deck 30 at the input end 16 of the mailing machine 10, or paused on the feed deck 30 at the entrance to the moistening/sealing module located in the area indicated by reference numeral 36. Once the printer maintenance has occurred, the control unit 20 will still associate the proper weight or postage rate (if already calculated based on the weight) with the mail piece that was paused within the mailing machine 10, thereby maintaining the integrity of the mail piece. By eliminating a delay until the printer maintenance is performed, the mailing machine 10 provides the highest quality, consistently printed indicia on each mail piece, without affecting the mail piece integrity and minimally impacting the throughput. If mailing machine 10 is printing the indicia on a tape from the tape drive 56, a tape will not be printed until the maintenance has been completed.

Another type of weighing and feeding error results when the user places a mail piece on the feed deck 30 without first having the weight of the mail piece being entered into the control unit 20. According to an embodiment of the present invention, if the queue 60 does not have an entry (and the mailing machine is not performing the full queue processing routine as described above), and the sensors 34 detect a mail piece on the feed deck 30 waiting to be processed by the mailing machine 10, a message will be displayed to the user, utilizing, for example the display 24, that indicates the weight was required for the mail piece. Thus, instead of remaining idle as previous conventional mailing machines, the mailing machine 10 will inform the user of the error. In the case of a mail piece that has been ingested and paused downstream waiting for a valid weight, the control unit 20 will cause the mailing machine to run the mail piece through the mailing machine without any processing being performed and eject the mail piece without being imprinted upon. A message will be displayed to the user, utilizing, for example the display 24, that indicates the weight was required for the mail piece. Thus, instead of remaining idle as previous conventional mailing machines, mailing machine 10 will eject the mail piece and inform the user of the error. The user, therefore, will be fully aware of the problem, and not make any assumptions with respect to the operating status of the mailing machine 10.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

1. A method for a mailing machine to process mail pieces comprising:
receiving information associated with a first mail piece from a scale;
processing the first mail piece utilizing the information associated with the first mail piece;
receiving information associated with a second mail piece from the scale and storing the information associated with the second mail piece while the first mail piece is being processed by the mailing machine;
retrieving the stored information associated with the second mail piece after the processing of the first mail piece has been completed by the mailing machine; and
processing the second mail piece utilizing the retrieved information associated with the second mail piece.

2. The method of claim 1, further comprising:
receiving information associated with a third mail piece from the scale and storing the information associated with the third mail piece while the first mail piece is being processed by the mailing machine.

3. The method of claim 2, further comprising:
retrieving the stored information associated with the third mail piece after processing of the second mail piece is complete; and
processing the third mail piece utilizing the retrieved information associated with the third mail piece.

4. The method of claim 1, wherein the information associated with the first and second mail pieces includes a respective weight of each mail piece.

5. The method of claim 1, wherein the information associated with the first and second mail pieces includes a respective postage amount for each mail piece.

6. The method of claim 1, wherein the information associated with the first and second mail pieces is stored in a memory having a configurable number of storage locations.

7. The method of claim 6, further comprising:
determining if each storage location in the memory is full; and
if each storage location is full, processing only mail pieces for which there is associated information currently stored in the memory and not storing information associated with any subsequent mail pieces.

8. The method of claim 1, further comprising:
providing an audible signal indicating when the information associated with the second mail piece can be stored.

9. The method of claim 1, wherein processing the first and second mail pieces includes generating a respective indicium for each of the first and second mail pieces and printing the generated indicium on the respective one of the first and second mail pieces.

10. The method of claim 1, further comprising:
determining that a maintenance operation is required for a print head of the mailing machine;
pausing the processing of the second mail piece after the second mail piece has entered the mailing machine and the information associated with the second mail piece has been retrieved;
performing the maintenance operation for the print head; and
resuming processing of the second mail piece.

11. The method of claim 1, further comprising:
ingesting the second mail piece into the mailing machine and pausing the second mail piece in the mailing machine while the first mail piece is being processed.

12. A method for processing mail pieces in a mailing machine that utilizes differential weighing to determine the weight of each mail piece, the method comprising:
removing a first mail piece from a scale coupled to the mailing machine, the scale providing information associated with the first mail piece to the mailing machine;
placing the first mail piece on a feed deck of the mailing machine, the mailing machine in response to the first mail piece being placed on the feed deck activating a transport to feed the first mail piece into the mailing machine for processing;
removing a second mail piece from the scale while the first mail piece is being processed by the mailing machine, the scale providing information associated with the second mail piece to the mailing machine, the mailing machine storing the information associated with the second mail piece in a memory;
placing the second mail piece on the feed deck of the mailing machine;
removing a third mail piece from the scale while the first mail piece is being processed by the mailing machine, the scale providing information associated with the third mail piece to the mailing machine, the mailing machine storing the information associated with the third mail piece in the memory,
wherein the mailing machine retrieves the information associated with the second mail piece stored in the memory after processing for the first mail piece has been completed and activates the transport to feed the second mail piece into the mailing machine for processing.

13. The method of claim 12, wherein the information associated with the first, second and third mail pieces includes a respective weight of each mail piece.

14. The method of claim 12, wherein the information associated with the first, second and third mail pieces includes a respective postage amount for each mail piece.

15. The method of claim 12, wherein the memory has a configurable number of storage locations.

16. The method of claim 15, further comprising:
determining if each storage location in the memory is full; and
if each storage location is full, processing only mail pieces for which there is associated information currently stored in the memory and not storing information associated with any subsequent mail pieces.

17. The method of claim 12, further comprising:
providing an audible signal indicating when the second and third mail pieces can be removed from the scale.

18. The method of claim 12, further comprising:
determining that a maintenance operation is required for a print head of the mailing machine;
pausing the transport after the second mail piece has entered the mailing machine and the information associated with the second mail piece has been retrieved;
performing the maintenance operation for the print head; and
resuming transport of the second mail piece through the mailing machine.

19. The method of claim 12, wherein placing the second mail piece on the feed deck further comprises:
ingesting the second mail piece into the mailing machine and pausing the second mail piece within the mailing machine while the first mail piece is being processed.

20. A mailing machine for processing mail pieces comprising:
a control unit to control operation of the mailing machine during processing of a mail piece, the processing including generation of an indicium for the mail piece and printing the indicium;
a transport device coupled to the control unit, the transport device transporting mail pieces through the mailing machine;
a scale coupled to the control unit; and
a memory device coupled to the control unit, the memory device adapted to store information associated with a plurality of mail pieces that the control unit receives from the scale, the control unit receiving from the scale and storing in the memory device information associated with at least one subsequent mail piece before processing for a preceding mail piece has been completed by the mailing machine,
wherein the control unit will retrieve the information stored for a subsequent mail piece after the processing of an immediately preceding mail piece has been completed and utilize the retrieved information associated with the subsequent mail piece for the processing of the subsequent mail piece.

21. The mailing machine of claim 20, wherein the information associated with the plurality of mail pieces includes a respective weight of each mail piece.

22. The mailing machine of claim 20, wherein the information associated with the plurality of mail pieces includes a respective postage amount for each mail piece.

23. The mailing machine of claim 20, wherein the memory device has a configurable number of storage locations.

24. The mailing machine of claim 23, wherein the control unit determines if each storage location in the memory is full, and if each storage location is full, controls the mailing machine to process only mail pieces for which there is associated information currently stored in the memory device and does not store information associated with any subsequent mail pieces.

25. The mailing machine of claim 20, further comprising:
means to provide an audible signal indicating when the information associated with a subsequent mail piece can be stored.

26. The mailing machine of claim 20, wherein if the control unit has not received information associated with a mail piece and a mail piece is detected for transportation by the transportation device, the control unit will cause the transport device to transport the detected mail piece through the mailing machine without performing any processing of the mail piece.
